(19) United States
(12) Patent Application Publication
(10) Pub. No.: US 2025/0389558 A1
(43) Pub. Date: Dec. 25, 2025

(54) METHOD FOR PRODUCING A SENSOR MODULE, AND SENSOR MODULE

(71) Applicant: Continental Autonomous Mobility Germany GmbH, Ingolstadt (DE)

(72) Inventors: Daniel Kohler, Kirchberg (DE); Franz Pfeiffer, Ulm (DE); Markus Vi Hung Thai, Balingen (DE); Max Dörfler, Wettstetten (DE)

(73) Assignee: Continental Autonomous Mobility Germany GmbH, Ingolstadt (DE)

(21) Appl. No.: 18/994,077

(22) PCT Filed: Jun. 7, 2023
(86) PCT No.: PCT/DE2023/200114

§ 371 Date: Jan. 14, 2025

(30) Foreign Application Priority Data
Jul. 14, 2022 (DE) 10 2022 207 224.3
Jul. 25, 2022 (DE) 10 2022 207 557.9

(51) Int. Cl. G01D 11/24; B29C 65/00; B29C 65/16; B29C 65/18; B29C 65/36

(52) U.S. Cl. CPC G01D 11/245; B29C 65/16; B29C 65/18; B29C 65/36; B29C 66/742

(57) ABSTRACT

A method for producing a sensor module including at least a sensor head, a metal cover, a connector module and a connector element. The method includes providing the connector element and the metal cover; applying the connector element to the metal cover, the connector element having, at least in a partial region on a side facing the metal cover, a meltable material and the metal cover having, at least in a partial region, on the side facing the connector element, an area to which the meltable material of the connector element is applied; heating the metal cover on a side facing away from the connector element, the meltable material melting as a result of the heating; creating a connection between the connector element and metal cover, at least in the area provided on the metal cover, by the meltable material; and fastening the sensor head to the metal cover.

### CROSS-REFERENCE TO RELATED APPLICATIONS

The present application is a National Stage Application under 35 U.S.C. § 371 of International Patent Application No. PCT/DE2023/200114 filed on Jun. 7, 2023, and claims priority from German Patent Application No. 10 2022 207 224.3 filed on Jul. 14, 2022, and German Patent Application No.10 2022 207 557.9 filed on Jul. 25, 2022, in the German Patent and Trademark Office, the disclosures of which are herein incorporated by reference in their entireties.

### TECHNICAL FIELD

The invention relates to a method for producing a sensor module and to a sensor module produced by this method.

### BACKGROUND

As the development of partially autonomous to fully autonomous vehicles progresses, the number of sensor modules required in the vehicles is steadily increasing. In addition, the specifications and tasks of the modules are changing more and more. Many sensors are mounted on the outside, and therefore must be waterproof and resistant to dirt/dust and chemicals. There is also an increase in the required performance of the sensors for autonomous driving.

It is known from the prior art, for example, to seal the gap between the connector and the metal plate with an adhesive or potting material. It is also known to seal the gap by means of an O-ring or similar seals and to attach the connector to the metal plate by screwing or a similar fastening process. Another known variant would be to overmold the connector on the metal plate by means of an injection-molding process.

The problem with these approaches is that, for example, the potting process is a very complex process and, to always obtain a good result, there are a lot of influencing factors, such as, for example, contaminants on the material, etc. Furthermore, sealing with an O-ring or similar seals can intensify the surging mechanism of the sensor. Moisture in the sensor will cause a decrease in the performance.

### SUMMARY

It is therefore an object of the present disclosure to disclose a method by means of which a sensor module which has great robustness and waterproofness can be produced at low cost.

This object is addressed by the subject matter of claims 1 and 4.

Further advantageous designs and embodiments are the subject of the subclaims.

First considerations were that the integration and sealing of the plastic connector into a sensor represent fundamental method steps. Therefore, these steps in particular should be improved and also optimized in terms of costs.

According to the present disclosure, therefore, a method for producing a sensor module consisting at least of a sensor head, a metal cover, a connector module and a connector element, with the following steps is proposed:
providing the connector element and the metal cover;
applying the connector element to the metal cover, the connector element having, at least in a partial region, on a side facing the metal cover a meltable material and the metal cover having, at least in a partial region, on the side facing the connector element an area to which the meltable material of the connector element is applied;
heating the metal cover on a side facing away from the connector element, the meltable material melting as a result of heating;
creating a connection between the connector element and the metal cover, at least in the area provided on the metal cover, by the meltable material; and
fastening the sensor head to the metal cover.

The connector element is designed, for example, as a plastic housing for the connector module. The connector element is designed in such a way that the connector module can be inserted into the connector element.

In the proposed method, the connector element is pressed onto the metal cover, the meltable material being directly above the area of the metal cover and the material and the area of the metal cover having a substantially identical geometry. Meanwhile, the metal cover is heated on the side facing away from the connector element to melt the meltable material. After melting, the meltable material flows onto the area intended for it, and thus creates a connection between the metal cover and the connector element.

The connector module can have all the common connector interfaces that are relevant for the automotive sector.

In an example design for creating the connection on the area of the metal cover, a structure into which the molten meltable material flows is provided. This structure is particularly advantageous because such a structure has, for example, grooves or, generally, depressions into which the liquid material can flow. This advantageously creates a more robust connection between the connector element and the metal cover.

The heating of the metal cover is carried out by means of a laser, a heating plate or inductively. These methods are a possible way of allowing the metal cover to be heated particularly evenly and quickly.

Furthermore, according to the present disclosure, a sensor module including at least a sensor head, a metal cover, a connector module and a connector element is proposed, the connector element having, at least in a partial region on a side facing the metal cover, a meltable material, the metal cover having, at least in a partial region on a side facing the connector element, an area to which the meltable material is applied, the connector element and the metal plate each having a central recess into which the connector module can be inserted and, by heating the metal cover, a connection between the connector element and the metal plate being created as a result of melting of the meltable material on the area of the metal cover.

The connector element is designed, for example, as a plastic housing for the connector module. The connector element is designed in such a way that the connector module can be inserted into the connector element.

In the proposed method, the connector element is pressed onto the metal cover, the meltable material being directly above the area of the metal cover and the material, and the area of the metal cover having a substantially identical geometry. Meanwhile, the metal cover is heated on the side facing away from the connector element to melt the meltable material. After melting, the meltable material flows onto the area intended for it, and thus creates a connection between the metal cover and the connector element.

The metal cover consists, for example, of the aluminum alloy AL99.5. However, other materials are also conceivable.

The connector module can have all the common connector interfaces that are relevant for the automotive sector.

In an example embodiment, the area of the metal cover has a structure which is designed in such a way that the meltable material flows into this structure to create a connection between the metal cover and the connector element. This structure is particularly advantageous because such a structure has, for example, grooves or, generally, depressions into which the liquid material can flow. This advantageously creates a more robust connection between the connector element and the metal cover.

In particular, the structure of the area of the metal cover is created by means of a laser, by punching or milling. These methods are material processing methods by means of which a structuring of the metal cover in a predefined region can be realized particularly easily. Other metal processing methods by means of which a structure can be created would also be conceivable.

In a further design, the area is arranged around the recess for the connector module in the form of a ring. This is advantageous because in this way, the size of the necessary sealing area can be reduced to the smallest necessary, which in turn has an influence on the required amount of meltable material.

Furthermore, the meltable material is particularly arranged on the connector element in the form of a ring around the recess for the connector module. An arrangement in the form of a ring is advantageous because in this way the amount of meltable material can be advantageously reduced and nevertheless sufficient sealing can be ensured.

Other geometries of the area and of the meltable material would also be conceivable, although, if the geometries change, it must be ensured that the two geometries substantially match.

When connecting the metal plate to the connector element, the connector module is arranged on the metal plate or in the connector element. The connector module may correspondingly already be integrated in the connector element or arranged in the recess in the metal plate before the connection step. There are no differences when creating the connection, which is why these variants are possible as alternatives without further adjustments.

The meltable material is a plastic. Basically, any plastic that has a lower melting point than the connector element itself can be used here.

Further advantageous designs are the subject of the drawings.

### BRIEF DESCRIPTION OF THE DRAWINGS

In the drawings:

FIG. 1 shows a schematic flow diagram of a method according to one embodiment of the present disclosure;

FIG. 2a shows a schematic representation of a connector element according to one embodiment of the present disclosure;

FIG. 2b shows a further schematic representation of a connector element according to a further embodiment of the present disclosure;

FIG. 3a shows a schematic representation of a metal cover according to one embodiment of the present disclosure;

FIG. 3b shows a further schematic representation of a metal cover according to a further embodiment of the present disclosure;

FIG. 4 shows a schematic representation of a connector element in combination with a metal cover according to one embodiment of the present disclosure;

FIG. 5 shows a schematic representation of a sensor module according to one embodiment of the present disclosure.

### DETAILED DESCRIPTION

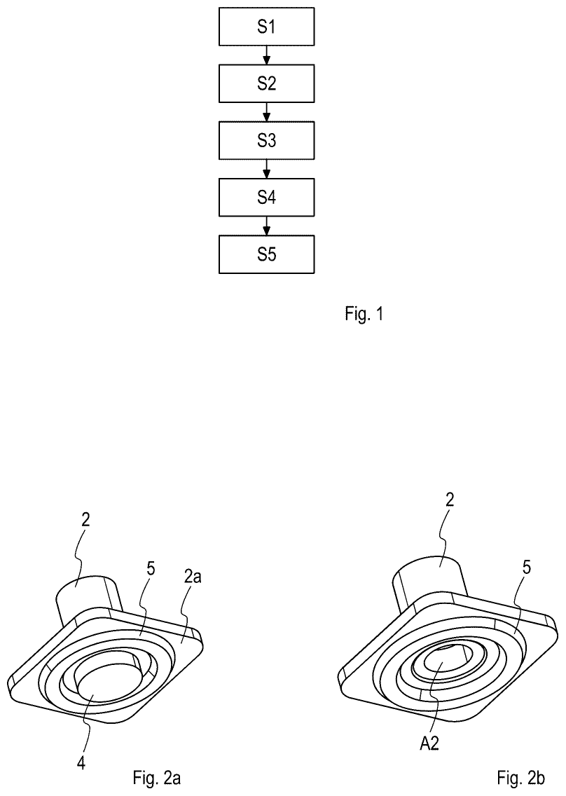

FIG. 1 shows a schematic flow diagram of a method according to one embodiment of the present disclosure. In step S1, the connector element 2 and the metal cover 3 are provided. In step S2, the connector element 2 is applied to the metal cover 3, the connector element 2 having, at least in a partial region on a side 2a facing the metal cover 3, a meltable material 5, and the metal cover 3 having, at least in partial region on the side 3a facing the connector element 2, an area F to which the meltable material 5 of the connector element 2 is applied. In step S3, the metal cover 3 is heated on a side 3b facing away from the connector element, the meltable material 5 being melted by the heating. In step S4, a connection between the connector element 2 and the metal cover 3 is created, at least in the area F provided on the metal cover, by the meltable material 5. In step S5, the sensor head 6 is fastened to the metal cover 3.

FIGS. 2a and 2b each show a schematic representation of a connector element according to one embodiment of the present disclosure. The connector element 2 of FIG. 2a has on the side 2a facing the metal cover a meltable material 5. Furthermore, in the design according to FIG. 2a, the connector module 4 is already integrated in the connector element 2. The representation of FIG. 2b substantially corresponds to FIG. 2a, though in FIG. 2b the connector module 4 is not arranged in the connector element 2, but instead the latter only has the recess A2.

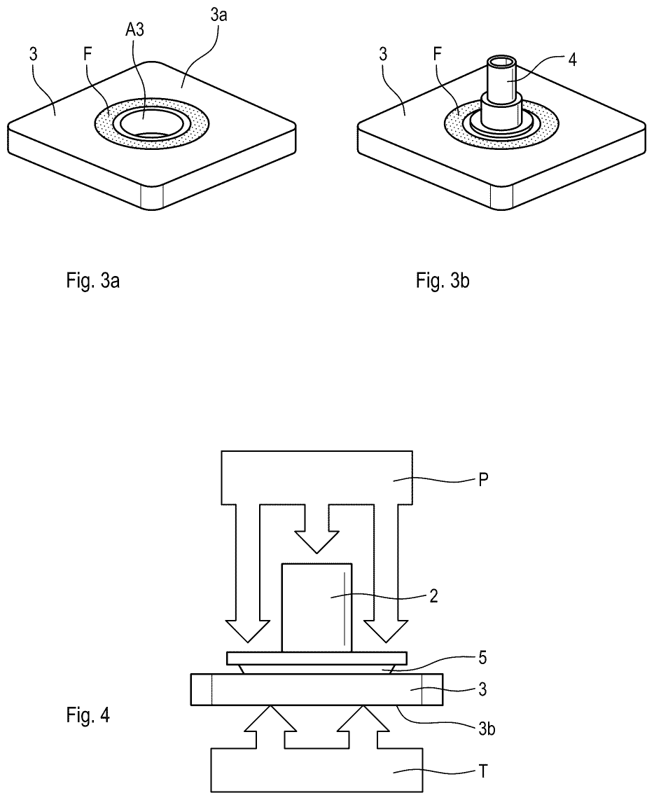

FIGS. 3a and 3b each show a schematic representation of a metal cover according to one embodiment of the present disclosure. In the representation of FIG. 3a, the metal cover 3 has on the side 3a facing the connector element an area F to which the meltable material 5 of the connector element 2 is applied. This area F may have structures for better durability of the connection. Shown in the center of the metal cover 3 is a recess A3 into which a connector module 4 can be inserted. The representation of FIG. 3b corresponds substantially to FIG. 3a, though in FIG. 3b the sensor module 4 is arranged in the recess A3 in the metal cover 3.

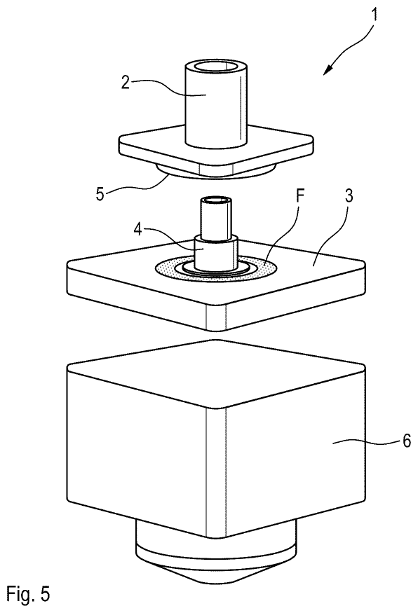

FIG. 4 shows a schematic representation of a connector element in combination with a metal cover according to one embodiment of the present disclosure. In this case, the connector element 2 is applied to the metal cover 3 with pressure P. In this representation, the meltable material 5 can be seen between the connector element 2 and the metal cover 3. The metal cover 3 is heated at a high temperature T on the side 3b facing away from the connector element 2 in order to melt the meltable material 5.

FIG. 5 shows a schematic representation of a sensor module according to one embodiment of the present disclosure. Here, the sensor module 1 includes a connector element 2 with meltable material 5 and a metal cover 3, the metal cover 3 having an area F to which the meltable material 5 is applied. Furthermore, in this embodiment the connector module 4 is arranged in the metal cover 3. As previously shown, the connector module 4 may also be arranged in the connector element 2 before the connector element 2 is connected to the metal cover 3. Furthermore, also provided for the sensor module 1 is a sensor head 6, which is connected to the metal cover 3.

### LIST OF REFERENCE SIGNS

1 Sensor module
2 Connector element
2a Side facing the metal cover
3 Metal cover
3a Side facing the connector element
3b Side facing away from the connector element
4 Connector module
5 Meltable material
6 Sensor head
A2 Recess in the connector element
A3 Recess in the metal cover
F Area
P Pressure
S1-S5 Method steps
T Temperature

1. A method for producing a sensor module comprising at least a sensor head, a metal cover, a connector module and a connector element, the method comprising:
providing the connector element and the metal cover;
applying the connector element to the metal cover, the connector element having, at least in a partial region on a side facing the metal cover, a meltable material and the metal cover having, at least in a partial region on the side facing the connector element, an area to which the meltable material of the connector element is applied;
heating the metal cover on a side facing away from the connector element, the meltable material melting as a result of the heating;
creating a connection between the connector element and the metal cover; at least in the area provided on the metal cover, by the meltable material;
fastening the sensor head to the metal cover.

2. The method as claimed in claim 1, wherein for creating the connection on the area of the metal cover, a structure into which the melted meltable material flows is provided.

3. The method as claimed in claim 1, wherein the heating of the metal cover is carried out by a laser, a heating plate or inductively.

4. A sensor module comprising at least a sensor head, a metal cover, a connector module and a connector element, the connector element having, at least in a partial region, on a side facing the metal cover, a meltable material, the metal cover having, at least in a partial region on a side facing the connector element, an area to which the meltable material is applied, the connector element and the metal plate, each having a central recess into which the connector module can be inserted and, by heating the metal cover, a connection between the connector element and the metal plate being created as a result of melting of the meltable material on the area of the metal cover .

5. The sensor module as claimed in claim 4, wherein the area of the metal cover has a structure which is defined in such a way that the meltable material flows into the structure to create a connection between the metal cover and the connector element.

6. The sensor module as claimed in claim 5, wherein the structure at the area of the metal cover is created by means of a laser, by punching or milling.

7. The sensor module as claimed in claim 5, wherein the area of the metal cover is arranged around the central recess for the connector module in the form of a ring.

8. The sensor module as claimed in claim 4, wherein the meltable material is arranged on the connector element in the form of a ring around the central recess for the connector module.

9. The sensor module as claimed in claim 4, wherein when connecting the metal cover to the connector element, the connector module is arranged on the metal cover or in the connector element.

10. The sensor module as claimed in claim 4, wherein the meltable material is a plastic.
